(19) United States
(12) Patent Application Publication
(10) Pub. No.: US 2020/0101908 A1
(43) Pub. Date: Apr. 2, 2020

(54) TOW EYE LICENSE PLATE MOUNTING SYSTEM

(71) Applicant: CAMISASCA AUTOMOTIVE MANUFACTURING, INC., Lake Forest, CA (US)

(72) Inventors: Henry P. Camisasca, Irvine, CA (US); Colin Camisasca, Newport Beach, CA (US)

(21) Appl. No.: 16/149,607

(22) Filed: Oct. 2, 2018

(51) Int. Cl. B60R 13/10

(52) U.S. Cl. CPC B60R 13/105; G09F 7/22

(57) ABSTRACT

A license plate mounting system for use with a vehicle tow eye socket. The license plate mounting system can include a shaft configured to releasably couple with the tow eye socket. A mounting plate configured to support a vehicle license plate. The mounting system also includes a swivel assembly configured to couple the mounting plate to the shaft, and to permit rotation of the mounting plate relative to the shaft about an adjustment axis. The swivel assembly can have a first swivel portion defining a curved surface having an arc length and a second swivel portion having an engagement surface that engages the curved surface. The engagement surface engages only a portion of the curved surface in any particular relative position. The second swivel portion is movable along the curved surface to permit angular adjustment of the mounting plate about the adjustment axis.

### BACKGROUND

### Field

The present disclosure relates to license plate mounting systems. In particular, the present disclosure relates to a license plate mounting system with an adjustable mounting bracket using the tow eye socket on automotive vehicles.

### Description of the Related Art

In a majority of states in the U.S., it is required by law to display a license plate on the front of the vehicle as well as the rear. This creates both functional and stylistic challenges for the manufacturers and owners of automotive vehicles. Many types of license plate mounting systems exist to secure license plates to vehicles. Some systems connect the mounting structure directly to the front bumper with a threaded fastener, which often results in holes being created in the bumper. Alternative systems have been developed, including some that utilize the tow eye socket of the vehicle as a mounting location. However, such existing license plate mounting arrangements often have a limited adjustability range or limited degrees of freedom of adjustment for the license plate. Additionally, current arrangements often fail to provide a sufficiently close fit of the license plate to the front bumper of the vehicle, at least while also providing sufficient adjustability. It is desirable for the license plate and mount to be kept close to the front bumper for aesthetic reasons, but also for safety reasons, such as to reduce the likelihood of objects getting snagged by the edge of the license plate/mounting plate or caught in the space between the license plate/mounting plate and the front bumper.

### SUMMARY

The systems, methods and devices described herein have innovative aspects, no single one of which is indispensable or solely responsible for their desirable attributes. Without limiting the scope of the claims, some of the advantageous features will now be summarized.

Configurations herein disclosed describe a license plate mounting system for use with a tow eye socket of a vehicle. In some configurations the license plate mounting system includes a shaft having a first end, a second end, and an intermediate portion between the first end and the second end, wherein the first end is configured to releasably couple with the tow eye socket. The license plate mounting system further includes a mounting plate configured to support a vehicle license plate, and a swivel assembly that couples the mounting plate to the shaft, and that permits rotation of the mounting plate relative to the shaft about an adjustment axis. The swivel assembly includes a first swivel portion defining a curved surface having an arc length, and a second swivel portion having an engagement surface that engages the curved surface, the engagement surface defining a dimension in a direction of the arc length, wherein the dimension is less than the arc length such that the engagement surface engages only a portion of the curved surface in any particular relative position, the second swivel portion movable along the curved surface to permit angular adjustment of the mounting plate about the adjustment axis.

In some configurations, the first swivel portion is connected to the mounting plate.

In some configurations, the second swivel portion is connected to the second end of the shaft.

In some configurations, the curved surface of the first swivel portion is defined by a first groove.

In some configurations, the first groove comprises a slot.

In some configurations, the engagement surface of the second swivel portion comprises a projecting wall that extends into the slot.

In some configurations, the second end of the shaft comprises a textured surface configured to increase grip on the second swivel portion.

In some configurations, the first swivel portion further comprises a second groove that is located on an opposite side of the first groove and receives a washer or a fastener that secures the swivel assembly to the shaft.

In some configurations, the mounting plate comprises a plurality of mounting locations, wherein the swivel assembly is connected to a selected one of the plurality of mounting locations to provide for adjustment of a position of the mounting plate relative to the shaft.

In some configurations, the mounting plate comprises at least one opening associated with the plurality of mounting locations, the at least one opening configured to permit access to the swivel assembly to allow for the angular adjustment of the swivel assembly.

In some configurations, a license plate mounting system includes a shaft having a first end, a second end, and an intermediate portion between the first end and the second end, wherein the first end is configured to releasably couple with the tow eye socket. The license plate mounting system further includes a mounting plate configured to support a vehicle license plate and a swivel assembly configured to couple the mounting plate to the shaft, and to permit rotation of the mounting plate relative to the shaft about an adjustment axis, wherein the adjustment axis is a virtual axis located on an opposite side of the mounting plate from the shaft.

In some configurations, the license plate mounting system comprises at least one opening in the mounting plate, the at least one opening configured to provide access to the swivel assembly to permit adjustment of the mounting plate about the adjustment axis.

In some configurations, a license plate mounting system includes a shaft having a first end, a second end, and an intermediate portion between the first end and the second end, wherein the first end is configured to releasably couple with the tow eye socket, a mounting plate configured to support a vehicle license plate, and a swivel member that couples the mounting plate to the shaft and permits rotation of the mounting plate relative to the shaft, the swivel member comprising a curved slot. The license plate mounting system further including a track member connected to the second end of the shaft, the track member configured to travel along the curved slot of the swivel member, and a fastener configured to secure the swivel member to the shaft. In response to the fastener being tightened, the swivel member is fixed relative to the track member and the shaft.

In some configurations the license plate mounting system further comprises a washer located on a side of the swivel member opposite the shaft, the washer configured to provide a friction fit between the swivel member and track member as a result of the fastener being tightened.

In some configurations, the mounting plate comprises an opening through which the swivel member can be accessed.

In some configurations, the swivel member, the track member and the fastener are configured to enable adjustment of the yaw and roll position of the mounting plate.

In some configurations, the curved slot follows at least a portion of a circular path, wherein a center of the circular path is on a side of the mounting plate opposite the swivel member.

### BRIEF DESCRIPTION OF THE DRAWINGS

These and other features and advantages of the present embodiments will become more apparent upon reading the following detailed description and with reference to the accompanying drawings of the embodiments.

FIG. 1 is an exploded perspective view of a license plate mounting system.

FIG. 2A is a cross-sectional view of the mounting system in an assembled state.

FIG. 2B is a cross-sectional view of the mounting system of FIG. 2A with the mounting plate swiveled at an angle.

FIG. 3 is a perspective view of a track member of the license plate mounting system of FIG. 1.

FIG. 4 is a perspective view of a swivel member of the license plate mounting system of FIG. 1.

FIG. 5 is a close-up perspective view of the assembled license plate mounting system of FIG. 1.

FIG. 6 is an exploded perspective view of one embodiment of the mounting system.

### DETAILED DESCRIPTION

Embodiments of systems, components and methods of assembly and manufacture will now be described with reference to the accompanying figures, wherein like numerals refer to like or similar elements throughout. Although several embodiments, examples and illustrations are disclosed below, it will be understood by those of ordinary skill in the art that the inventions described herein extends beyond the specifically disclosed embodiments, examples and illustrations, and can include other uses of the inventions and obvious modifications and equivalents thereof. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

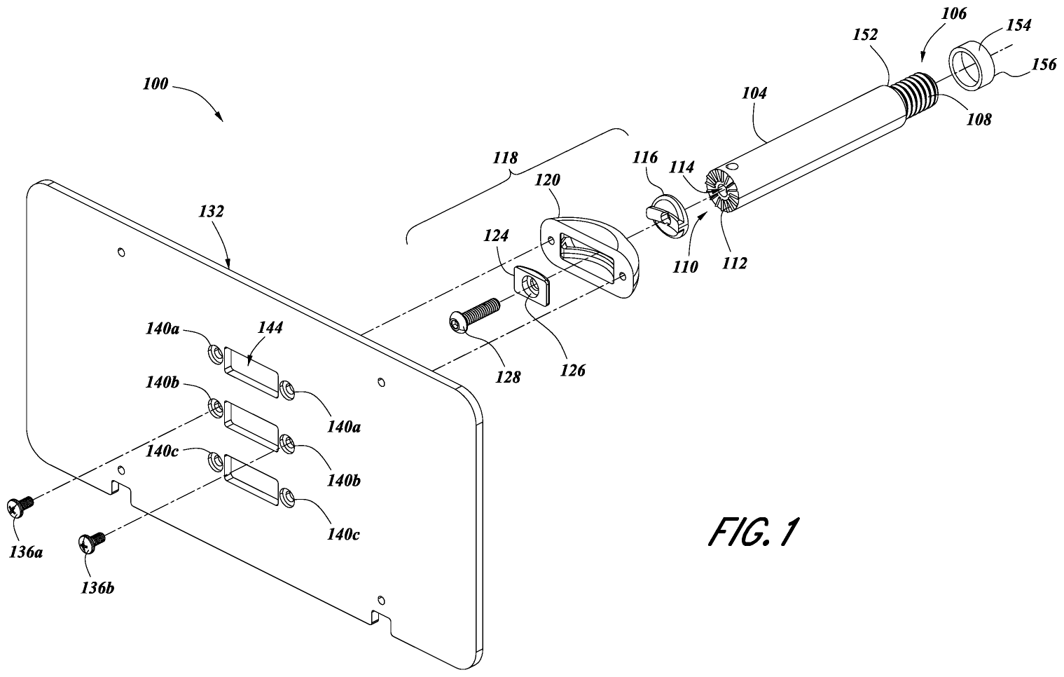

With reference to FIG. 1, a license plate mounting assembly 100 can comprise a system for adjustably mounting a license plate to a vehicle using a tow eye socket (not shown) of the vehicle. A tow eye socket is typically a threaded mount facing generally in a forward direction on the vehicle and configured to receive a tow eye, which provides a connection location for towing of the vehicle. Because the tow eye socket is not normally used, it can provide a desirable location for mounting of a front license plate that does not require the creation of holes in the front bumper or other portions of the front fascia of the vehicle. Relative directional terminology used herein is in the context of the assembly 100 mounted to a tow hook at the front of the vehicle. However, the assembly 100 could also be employed with other similar mounting structures on, for example, the rear of the vehicle or for other applications. Thus, the positional relationships described herein are not intended to be limiting unless otherwise indicated. The assembly 100 can comprise a shaft 104 configured to be inserted into and releasably coupled with the tow eye socket of a vehicle. A mounting plate 132 configured to support a license plate is coupled to the shaft 104 by an adjustment arrangement 118. The adjustment arrangement 118 permits adjustment of the mounting plate 132 relative to the shaft 104 about at least one axis. In some configurations, the adjustment arrangement 118 permits adjustment of the mounting plate 132 relative to the shaft 104 about two or more axes.

The shaft 104 can comprise a first end 106 comprising external threads 108. The threads 108 of the first end 106 can be configured to thread into corresponding internal threads of the tow eye socket. One of skill in the art will appreciate that other means of securing the shaft 104 to a tow eye socket can be used depending on the type of tow eye socket. The shaft 104 can further comprise a second end 110 opposite the first end 106 of the shaft 104. The first end 106 can also define a shoulder 152 that can abut against the tow eye socket of the vehicle. A length between the shoulder 152 of the first end 106 and the second end 110 preferably is selected to locate the adjustment arrangement 118 and the mounting plate 132 desirably close to the corresponding surface of the vehicle when the shoulder 152 abuts the tow eye socket. Advantageously, the provision of the shoulder 152 provides for precise positioning of the adjustment arrangement 118 and the mounting plate 132. The length can vary per vehicle, thus, the shaft 104 can be vehicle-specific. However, if desired, the shaft 104 can be length-adjustable.

The second end 110 can comprise friction or grip-enhancing features or members 112, such as a plurality of ribs or protrusions or other surface features that provide the second end 110 with a textured surface to enhance the rotational stability of the mounting plate 132 and/or the adjustment arrangement 118 relative to the shaft 104 once adjusted into a desirable relative position. In other words, the textured surface of the second end 110 preferably assists in inhibiting or preventing undesired relative rotation between the shaft 104 and the mounting plate 132/adjustment arrangement 118 in response to normal or expected forces during use, such as by engaging surface irregularities in, or by slightly deforming or biting into the surface of, the cooperating surface of the track member 116. The second end 110 of the shaft 104 can also comprise a threaded opening 114 configured to receive a fastener 128 of the adjustment arrangement 118.

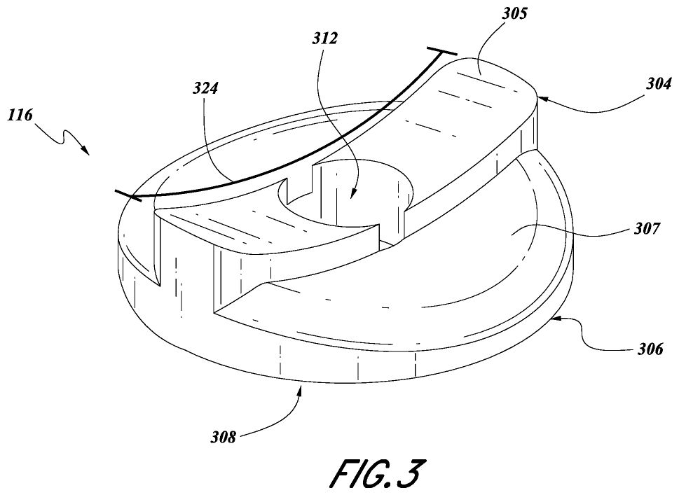

With reference to FIGS. 1 and 3, the adjustment arrangement 118 can comprise a track member 116 and a swivel member 120 that cooperate to permit adjustment of the mounting plate 132 relative to the shaft 104 about at least one axis. The swivel member 120 is rotatable relative to the track member 116, which moves along a surface of the swivel member 120 as the swivel member 120 rotates. The track member 116 can comprise a substantially flat side 308 that is configured to contact the second end 110 of the shaft 104. The flat side 308 of the track member 116 can be configured to abut the second end 110 of the shaft 104 such that the grip-enhancing features 112 engage the flat side 308 of the track member 116 and deter rotation of the track member 116 relative to the shaft 104 once adjusted and secured in place. In other arrangements, the flat side 308 of the track member 116 could also include grip-enhancing features complementary to the grip enhancing features 112 of the shaft 104. However, the Applicant has determined that the including grip-enhancing features on only one surface is capable of resisting rotation to a satisfactory extent and also allows for infinite rotational adjustability. When grip-enhancing features are provided on both surfaces, the features can tend to move towards discrete interlocking positions, which can result in discrete rather than infinite or continuous adjustability.

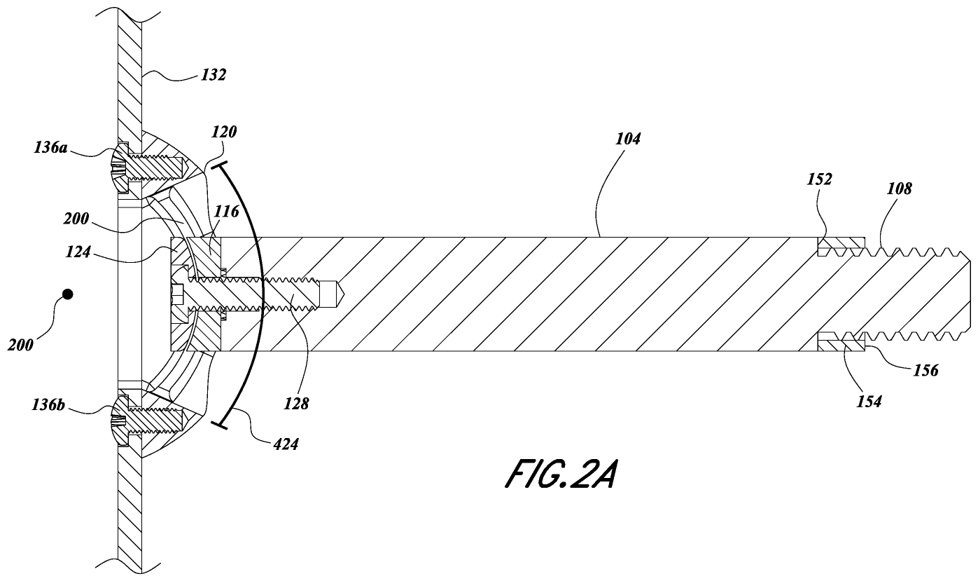

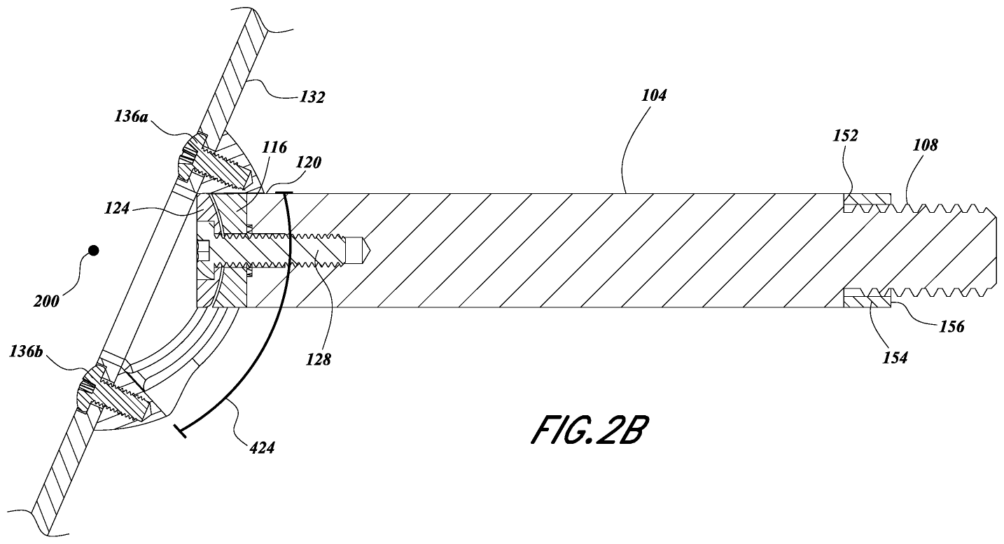

The track member 116 can further comprise a second side opposite the flat side 308. The second side of the track member 116 can comprise a projection, a projecting rib or a track 304. In some configurations, the track 304 can comprise a curved front surface 305. In the illustrated arrangement, the base portion 306 also has a curved front surface 307. In some configurations, the radius of the curved surfaces 305, 307 are equal or substantially equal. The track member 116 can further comprise a hole 312 configured to permit the fastener 128 to pass through the track member 166 to be threaded into the opening 114 of the shaft 104, as illustrated in the cross-sectional view of FIG. 2A.

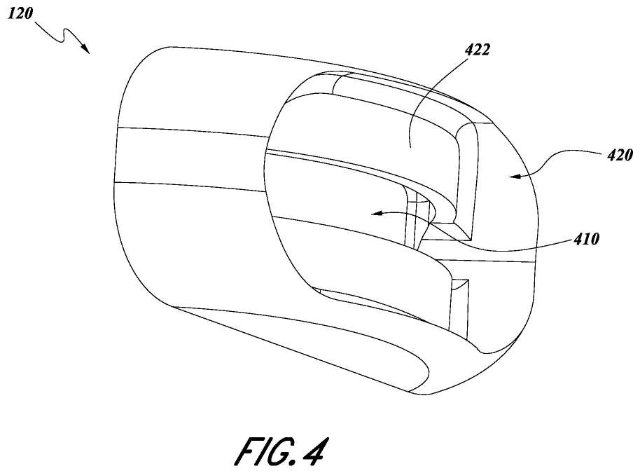

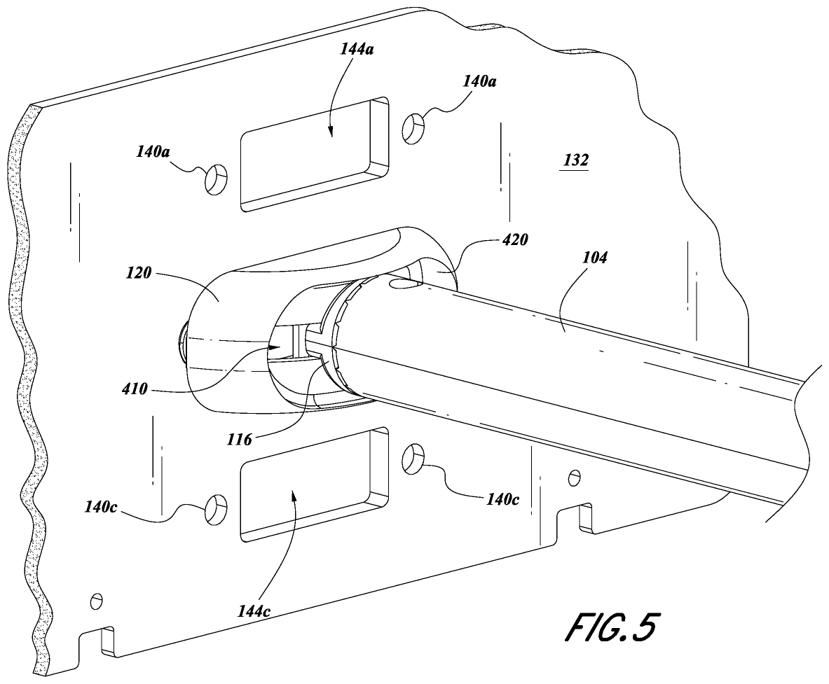

With reference to FIGS. 1, 4, and 5, as described above, the swivel member 120 can be configured to adjustably couple with the track member 116. For example, the swivel member 120 can comprise a first groove 420 defining a curved surface 422 (e.g., a part-cylindrical surface) having an arc length 424 (FIGS. 2A and 2B). The first groove 420 can be located in a side of the swivel member 120 facing or nearest the shaft 104. A slot or opening 410 interrupts the curved surface 422 of the first groove 420. The slot 410 is configured to receive the track 304 of the track member 116. The first groove 420 and slot 410 can be configured to allow the track 304 to travel along a length of the slot 410 with the curved surface 307 of the track member 116 in sliding engagement with the curved surface 422 of the swivel member 120. The track 304 can occupy a substantial entirety of a width of the slot 410 to inhibit or substantially prevent undesirable rotation of the swivel member 120 relative to the track member 116.

The track member 116 can define a dimension, or arc length 324, in a direction of the arc length 424 of the first groove 420 that is less than the arc length 424 of the first groove 420. With such an arrangement, the track member 116 engages only a portion of the first groove 420 and/or slot 410 in any particular position of the track member 116 relative to the swivel member 120. Accordingly, the swivel member 120 can slide relative to the track member 116 to allow for angular adjustment of the swivel member 120, and thus the mounting plate 132, about a substantially vertical axis in use. In some configurations, the track member 116 can be secured to the swivel member 120 (e.g., the track 304 is secured in the first groove 420) such that the track 304 is free to travel along the groove 420 but is unable to be removed completely from the first groove 420. Such an arrangement loosely couples the swivel member 120 to the track member 116 to facilitate angular adjustment. Once a desirable position has been obtained, the track member 116 and the swivel member 120 can be secured (e.g., by the fastener 128) in the adjusted position. In some configurations, the adjustment arrangement 118 provides for at least about 40-60 degrees of angular adjustment. Furthermore, if desired, a part-spherical surface can be provided to permit angular adjustment about two axes of rotation (e.g., yaw and pitch angle adjustment).

In some configurations, the first groove 420 of the swivel member 120 is curved such that curved surface 422 defines at least a portion of a circular path. The curve can be directed away from the shaft 104 such that a center 200 of the curved surface 422 of the first groove 420 is forward of one or more of the adjustment arrangement 118, the mounting plate 132, and the vehicle. In other words, an adjustment axis of rotation, which is a virtual axis of rotation of the swivel member 120 passing through the center 200, is located on an opposite side of the swivel member 120 from the shaft 104 (e.g., in front of the mounting plate 132). The distance of the adjustment axis from the swivel member 120 depends on the radius of the curved surface 422 of the first groove 420. For example, as the radius of the curved surface 422 increases, the center 200 and virtual adjustment axis moves further away from the swivel member 120. A larger radius of the curved surface 422 facilitates fine adjustment of the mounting plate 132 angle, but requires a greater distance of movement to achieve a given angular adjustment, which would increase a width of the swivel member 120 to provide the same range of angular adjustment. Preferably, the radius of the curved surface 422 is selected to provide a desirable balance between fine adjustment and distance of movement/width of the swivel member 120.

The swivel member 120 can further comprise a second groove 122 disposed opposite the first groove 420 (e.g., on a forward side of the swivel member 120 in an in-use orientation). The second groove 122 defines a curved surface preferably having a radius and an arc length that are equal to or approximately equal to the curved surface 422 of the first groove 420. The slot 410 can also communicate with the second groove 122 such that the slot 410 extends between the first groove 420 and the second groove 122, thereby creating a passage between the grooves 122, 410. As discussed in greater detail below, the second groove 122 can be configured to provide a path along which the fastener 128 travels as the swivel member 120 is adjusted.

With reference to FIGS. 1 and 2, in some configurations, the assembly 100 can comprise a washer 124. The washer 124 can be adjustably disposed in the second groove 122. The dimensions of the washer 124 can be less than the arc length of the second groove 122 such that the washer 124 resides at only a portion of the second groove 122 in any particular relative position. In other words, the dimensions of the washer 124 can be such that the washer 124 is free to travel within the length of the second groove 122. The washer 124 can include a curved surface that engages the curved surface of the second groove 122 and has a radius that is substantially equal to the radius of the curved surface of the second groove 122. A height of the washer 128 preferably is greater than a height of the slot 410 such that the washer does not fit through the slot 410.

The washer 124 can comprise an opening 126 through which the fastener 128 passes in use. The washer 124 can be configured to distribute load of the fastener 128 over a greater area of the curved surface of the second groove 122 than the fastener head itself. As a result, the washer 124 can aid in providing a friction or pressure fit engagement between the swivel member 120 and the track member 116 as the fastener 128 is tightened into the shaft 104. In some configurations, the washer 124 can be secured within the second groove 122 such that the washer 124 is free to travel along the second groove 122 but is unable to be removed from the second groove 122.

As an example operation of the angular adjustment (yaw adjustment) of the assembly 100, the fastener 128 can be configured to pass through the washer 124, the swivel member 120, and the track member 116 to be threaded into the opening 114 of the shaft 104. Because of the grooves 122, 420 and the slot 410, even with the fastener 128 in place, the track member 116 can be free to pivot along the path created by the curved surfaces of the grooves 122, 420. However, as the fastener 128 is tightened into the shaft 104, the washer 124, swivel member 120, track member 116, and shaft 104 are compressed, thereby (e.g., frictionally) securing their positions in relation to one another. In other words, with the fastener 128 is a loosened state, the swivel member 120 is free to swivel relative to the track member 116 and the shaft member 104, however, with the fastener in a tightened state, the swivel member 120 is “pinched” between the fastener 128 and the track member 116, thereby fixing the swivel member's location with respect to the shaft 104.

To adjust the angle of the swivel member 120 relative to the shaft 104, the fastener 128 can be loosened until the swivel member 120 can be slid along the track member 116, thereby changing the angle of the swivel member 120 relative to the shaft 104. An advantage of this configuration is that the fastener 128 does not need to be completely removed from the shaft 104, but only loosened, to adjust the position of the swivel member 120.

With reference to FIGS. 1, 2, and 5, the assembly 100 can comprise a mounting plate 132 on which a vehicle's license plate can be mounted. The mounting plate 132 can be made of one or more materials, such as stainless steel, plastic, polymer, 304 Grade stainless steel, Black ABS Hair Cell Plastic, and/or aluminum, among other materials that are suitable for complying with industry standards, withstanding various weather conditions, increasing durability, and decreasing cost. The dimensions of the mounting plate 132 can be approximately proportionate to the vehicle's license plate.

The mounting plate 132 can comprise a plurality of mounting positions 140a, 140b, and 140c (collectively 140) configured to receive fasteners 136a, 136b. The mounting plate 132 can be configured to couple with the swivel member 120 via the fasteners 136a, 136b. The mounting plate 132 can be secured by any number of suitable fasteners 136a, 136b. For example, the fasteners 136a, 136b can machine screws or self-drilling screws that are the same as or similar to those normally used for mounting a license plate to the relevant vehicle, among other possible options. Each of the fasteners 136a, 136b can include a same or varying length. The length of the fasteners can depend on the thickness of the mounting plate 132 and mounting hardware in some instances.

The mounting plate 132 may further comprise one or a plurality of slots (collectively or generically 144) through which the fastener 128 can pass and be accessed. Although in the illustrated arrangement a discrete slot 144 is provided for each set of mounting holes 140a, 140b, 140c, in other arrangements a single slot 144 or other opening can cooperate with more than one (or all) of the mounting holes 140a, 140b, 140c. With the mounting plate 132 coupled to the swivel member 120, one of the slots 144 is aligned with the second groove 122. Thus, an advantage of the present configuration is the ability of the fastener 128 to be accessed without having to remove the mounting plate 132 from the swivel member 120. Further, the slots 144 of the mounting plate 132 enable adjustment of the mounting plate's position (e.g., yaw) without having to disassemble any portion of the assembly 100.

Moreover, the fastener 128 can be conveniently accessed from the front of the mounting plate 132 by passing a tool (e.g., a screwdriver) through a relevant one of the slots 144. In some configurations, the fastener 128 may extend partially or fully through the slot 144 such that the tool does not pass through the slot 144 during the adjustment process. Certain prior art designs require adjustment access from behind the mounting plate—such as from the top, bottom or sides. Such an arrangement often requires a tool access gap to be provided between the rear side of the mounting plate and the corresponding surface of the vehicle, which spaces the mounting plate further from the vehicle than desired and can create a snagging hazard. By permitting tool access from the front, the illustrated arrangement of the assembly 100 advantageously allows a closer fit to the body of the vehicle. In some configurations, the plurality of mounting positions 140 can be arranged such that the “height” of the mounting plate 132 in relation to the swivel member 120 and/or shaft 104 can be adjusted.

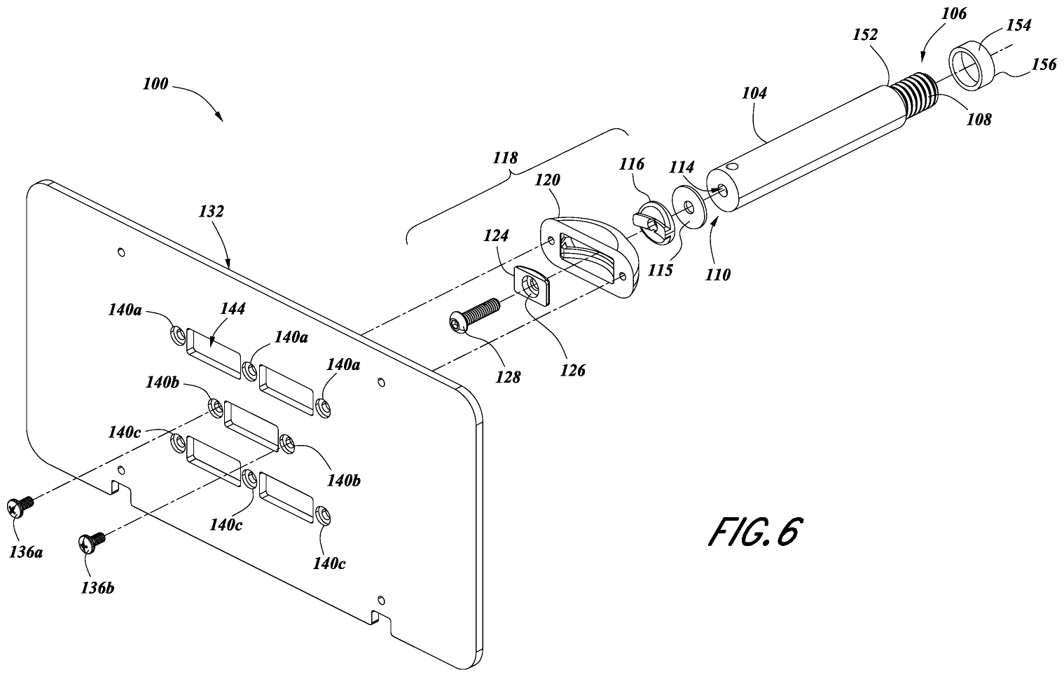

With reference to FIG. 6, in some embodiments the assembly 100 can include a washer 115 (e.g., a fiber washer) configured to be placed between the shaft 104 and the track member 116. The washer 115 can serve as an anti-rotation member to inhibit or prevent rotation between the shaft 104 and the track member 116 at least in response to normal or expected forces in use. Additionally, in some embodiments, the second end 110 of the shaft 104 can be flat (i.e., without the grip-enhancing members 112). This can reduce the cost of manufacturing the shaft 104 as well as provide a flat surface that is better suited to engage the washer 115.

The adjustability of the assembly 100 will now be described. Based on the above described configurations, the yaw angle of the mounting plate 132 can be adjusted by loosening the fastener 128 and rotating the mounting plate 132 such that the swivel member 120 slides, via the slot 410, along the track 304 of the track member 116. Yaw angle adjustment of the mounting plate 132 allows the license plate to be aligned with a vehicle's front bumper. In some configurations, the roll angle, or angle about the axis of the shaft 104, of the mounting plate 132 can be adjusted by loosening the fastener 128 and rotating the track member 116 in relation to the shaft 104. In some configurations, the vertical position of the mounting plate 132 in relation to the shaft 104 can be adjusted using a desired one of the plurality of mounting positions 140a, 140b, 140c and slots 144 to mount the mounting plate 132 in different positions relative to the swivel member 120. Further, as is shown in FIG. 6, additional mounting locations could be provided to one or both sides of the illustrated mounting positions 140a, 140b, 140c to provide side-to-side adjustability of the mounting plate 132 relative to the shaft 104. As described above, fore-aft adjustment can be accomplished by providing shafts 104 of different lengths (e.g., vehicle-specific lengths). However, if desired, the shaft 104 could be length adjustable. For example, a spacer member 154 could be provided that fits over the shaft 104 and defines an optional second shoulder surface 156, as illustrated in the arrangement of FIGS. 1-2B. Such an arrangement can permit a single assembly 100 to fit at least two different vehicles at a much lower manufacturing cost than many options for providing a length-adjustable shaft 104. However, if desired, an adjustable shaft 104 could incorporate a turn-buckle-type adjustment arrangement, among other possibilities, to provide a greater range of length adjustment and/or finer length adjustment.

Additional Considerations

The materials of the components described herein can be selected to comply with standards and requirements of various jurisdictions. The materials can advantageously be weather-proof or be selected to withstand various weather conditions. The materials can be selected to be durable, flexible, rigid, and/or decrease the overall cost of the system.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

What is claimed is:

1. A license plate mounting system for use with a tow eye socket of a vehicle, the license plate mounting system comprising:
a shaft having a first end, a second end, and an intermediate portion between the first end and the second end, wherein the first end is configured to releasably couple with the tow eye socket;
a mounting plate configured to support a vehicle license plate; and
a swivel assembly that couples the mounting plate to the shaft, and that permits rotation of the mounting plate relative to the shaft about an adjustment axis, the swivel assembly comprising:
a first swivel portion defining a curved surface having an arc length; and
a second swivel portion having an engagement surface that engages the curved surface, the engagement surface defining a dimension in a direction of the arc length, wherein the dimension is less than the arc length such that the engagement surface engages only a portion of the curved surface in any particular relative position, the second swivel portion movable along the curved surface to permit angular adjustment of the mounting plate about the adjustment axis.

2. The license plate mounting system of claim 1, wherein the first swivel portion is connected to the mounting plate.

3. The license plate mounting system of claim 1, wherein the second swivel portion is connected to the second end of the shaft.

4. The license plate mounting system of claim 1, wherein the curved surface of the first swivel portion is defined by a first groove.

5. The license plate mounting system of claim 4, wherein the first groove comprises a slot.

6. The license plate mounting system of claim 5, wherein the engagement surface of the second swivel portion comprises a projecting wall that extends into the slot.

7. The license plate mounting system of claim 1, wherein the second end of the shaft comprises a textured surface configured to increase grip on the second swivel portion.

8. The license plate mounting system of claim 1, wherein the first swivel portion further comprises a second groove that is located on an opposite side of the first groove and receives a washer or a fastener that secures the swivel assembly to the shaft.

9. The license plate mounting system of claim 1, wherein the mounting plate comprises a plurality of mounting locations, wherein the swivel assembly is connected to a selected one of the plurality of mounting locations to provide for adjustment of a position of the mounting plate relative to the shaft.

10. The license plate mounting system of claim 9, wherein the mounting plate comprises at least one opening associated with the plurality of mounting locations, the at least one opening configured to permit access to the swivel assembly to allow for the angular adjustment of the swivel assembly.

11. A license plate mounting system for use with a tow eye socket of a vehicle, the license plate mounting system comprising:
a shaft having a first end, a second end, and an intermediate portion between the first end and the second end, wherein the first end is configured to releasably couple with the tow eye socket;
a mounting plate configured to support a vehicle license plate; and
a swivel assembly configured to couple the mounting plate to the shaft, and to permit rotation of the mounting plate relative to the shaft about an adjustment axis, wherein the adjustment axis is a virtual axis located on an opposite side of the mounting plate from the shaft.

12. The license plate mounting system of claim 11, further comprising at least one opening in the mounting plate, the at least one opening configured to provide access to the swivel assembly to permit adjustment of the mounting plate about the adjustment axis.

13. A license plate mounting system for use with a tow eye socket of a vehicle, the license plate mounting system comprising:
a shaft having a first end, a second end, and an intermediate portion between the first end and the second end, wherein the first end is configured to releasably couple with the tow eye socket;
a mounting plate configured to support a vehicle license plate;
a swivel member that couples the mounting plate to the shaft and permits rotation of the mounting plate relative to the shaft, the swivel member comprising a curved slot;
a track member connected to the second end of the shaft, the track member configured to travel along the curved slot of the swivel member; and
a fastener configured to secure the swivel member to the shaft;
wherein, in response to the fastener being tightened, the swivel member is fixed relative to the track member and the shaft.

14. The license plate mounting system of claim 13 further comprising a washer located on a side of the swivel member opposite the shaft, the washer configured to provide a friction fit between the swivel member and track member as a result of the fastener being tightened.

15. The license plate mounting system of claim 13, wherein the mounting plate comprises an opening through which the swivel member can be accessed.

16. The license plate mounting system of claim 13, wherein the swivel member, the track member and the fastener are configured to enable adjustment of the yaw and roll position of the mounting plate.

17. The license plate mounting system of claim 13, wherein the curved slot follows at least a portion of a circular path, wherein a center of the circular path is on a side of the mounting plate opposite the swivel member.
